(19) United States
(12) Patent Application Publication
(10) Pub. No.: US 2008/0038697 A1
(43) Pub. Date: Feb. 14, 2008

(54) Method of filling root canal with electro-conductive filler

(76) Inventor: Arkady Pavlov, Brooklyn, NY (US)

Correspondence Address: GLOBAL INNOVATIONS & PATENT CONSULTING, 2738 East 28th Suite, Brooklyn, NY, 11235, US

(21) Appl. No.: 11/503,348

(22) Filed: Aug. 14, 2006

(51) Int. Cl. A61C 5/02

(52) U.S. Cl. 433/224

(57) ABSTRACT

The present invention concerns a dental surgery practice, particularly a root canal treatment method. The method consists of a placement of the electra conductive filler of the determined length in the prepared root canal and a precise alignment of the bottom end of the electro-conductive filler with the root canal apex. What is more, the precise alignment is achieved by utilizing the readings on the Apex locator device, which is connected to the top part of the electro-conductive filler.

This method employs the electro-conductive filler, which is made as a traditional gutta-percha point with a superficial silver plating or as an electro-conductive rod made from a biologically neutral material (Ag, Ti), placed inside of a shell, which is made from a traditional gutta-percha material.

### FIELD OF INVENTION

A present invention concerns a dental surgery practice, namely a method of a root canal treatment.

A modern technology of the root canal treatment includes: opening of the top part of a tooth, preparation of the root canal (removal of a pathogenic bacteria), determination of the root canal apex and the length of a filler, as well as, filling the root canal with the filler by precisely aligning the bottom end of said filler with the root canal apex. In current dental technology a gutta-percha point is mostly utilized as a filler.

During the root canal treatment it is extremely important to not only correctly establish the root canal apex and determine the length of the filler, but also precisely align the bottom end of said filler with already established root canal apex. Incorrect execution of each of these requirements leads to the root canal treatment failure.

In modern dental practice the exact establishment of the root canal apex is carried out by the Apex locator device, where one electrode is placed in the root canal, and another one is attached to the patient's body. The determined length of the root canal allows the establishment of the required length for the gutta-percha point.

Even the most experienced dental professionals utilizing a modern technology not always are able to exactly align the bottom end of said filler to the root canal apex. It requires a numerous X-ray pictures to determine accuracy of the performed procedure.

The utilization of the existing method creates the following limitations:
a need of a numerous X-ray pictures that leads to unnecessary patient's radiation;
extra-time spent on performing numerous X-ray pictures, that considerably extends a cycle of medical procedures;
increased utilization of supporting materials for numerous quantity of X-ray pictures.

The purpose of the present invention is to eliminate the marked limitations. This goal is achieved by placing the electro-conductive filler in the prepared root canal, then, connecting the top part of said electro-conductive filler to the Apex locator device, and finally, aligning the bottom end of said electro-conductive filler with the root canal apex, according to the readings on the Apex Locator device.

### SUMMARY

The present invention allows for precise alignment of the bottom end of the electro-conductive filler with the root canal apex according to the readings on the Apex Locator device instead of performing numerous X-ray pictures of a treated tooth.

The offered method decreases the patient's radiation to a minimum, removes numerous unnecessary X-ray procedures, reduces the time for medical treatment, and decreases the usage of supporting materials, such as X-ray films, insulating materials, etc.

### DETAILED DESCRIPTION OF INVENTION

The offered invention can be utilized, as follows:

After a root canal opening, it is cleaned and washed to remove a pathogenic bacteria. Then, a root canal apex is established and a length of a filler is determined. After that an electro-conductive filler of the established length is placed in a prepared (cleared and washed out) root canal.

A top part of said electro-conductive filler is attached to an Apex locator device.

The bottom end of said electro-conductive filler is precisely aligned with the root canal apex based on the readings from Apex locator device.

Electro-conductive filler can be made from a traditional gutta-percha point, which is covered with a thin layer of electro-conductive material, for example, silver.

Another method of manufacturing electro-conductive filler comprises of a core made from biologically neutral electro-conductive material (for example, titan), which is placed inside of a shell, made from traditionally used gutta-percha material.

The utilization of the offered invention allows precise alignment of the bottom end of the electro-conductive filler with the root canal apex by connecting Apex locator device to the top part of the electro-conductive filler. In this place said electro-conductive filler carries out a function of an electrode of said Apex locator device. It allows the elimination of the labor-and-time consuming operations on performing numerous X-ray pictures and considerably reduces the duration of required medical procedures.

1. A method of a root canal filling with an electro-conductive filler comprises:
preparing the root canal prior to filling it with the filler,
establishing a root canal apex and determining a length of the filler,
placing the electro-conductive filler of the determined length in the prepared root canal;
connecting an Apex locator device to a top part of the electro conductive filler;
aligning a bottom end of said electro-conductive filler with the root canal apex according to the readings on the Apex locator device.

2. The method of claim 1, wherein said electro-conductive filler made as a traditional gutta-percha point with a superficial silver plating.

3. The method of claim 1, wherein said electro-conductive filler made as an electro-conductive rod, made from a biologically neutral material, which is placed inside of shell, made from traditional gutta-percha material.

4. The method of claim 3, wherein said biologically neutral material is silver or titan.
